(19) United States
(12) Patent Application Publication
(10) Pub. No.: US 2022/0212996 A1
(43) Pub. Date: Jul. 7, 2022

(54) GYPSUM PANELS, SYSTEMS, AND METHODS

(71) Applicant: Georgia-Pacific Gypsum LLC, Atlanta, GA (US)

(72) Inventors: Yongan Yuan, Westfield, IN (US); Stuart Brandon Gilley, Atlanta, GA (US)

(73) Assignee: Georgia-Pacific Gypsum LLC, Atlanta, GA (US)

(21) Appl. No.: 17/608,492

(22) PCT Filed: May 6, 2020
(86) PCT No.: PCT/IB2020/054288

§ 371 Date: Nov. 3, 2021

Related U.S. Application Data
(60) Provisional application No. 62/843,790, filed on May 6, 2019.

(51) Int. Cl. C04B 28/14; C04B 14/06; C04B 14/30; C04B 22/16

(52) U.S. Cl. CPC C04B 28/14; C04B 14/062; C04B 2111/00629; C04B 22/16; C04B 14/303

(57) ABSTRACT

Disclosed is a gypsum panel comprising a gypsum core comprising set gypsum and a colloidal material comprising colloidal silica, colloidal alumina, or both.

### CLAIM OF PRIORITY

This patent application claims the benefit of priority of U.S. Provisional Patent Application Ser. No. 62/843,790, filed on May 6, 2019, which is hereby incorporated by reference herein in its entirety.

### BACKGROUND

The present invention relates generally to the field of panels for use in building construction, and more particularly to gypsum panels and methods of making gypsum panels.

Typical building panels, such as interior building panels, building sheathing, or roof panels, include a core material, such as gypsum, and a mat facer, such as a paper facer or fiberglass mat facer. During manufacturing, the gypsum core material is traditionally applied as a slurry to a surface of the mat facer and allowed to set, such that the mat facer and gypsum core are adhered at the interface. Conventionally, such panels are heavy—with weights above 2000 lbs/msf—and lighter panels may suffer from performance issues and/or require costly ingredients to achieve certain properties (e.g., physical properties and fire resistance).

Accordingly, it would be desirable to provide lightweight panels having improved physical properties and fire resistance.

### BRIEF DESCRIPTION OF THE DRAWINGS

Referring now to the drawings, which are meant to be exemplary and not limiting, and wherein like elements are numbered alike. The detailed description is set forth with reference to the accompanying drawings illustrating examples of the disclosure, in which use of the same reference numerals indicates similar or identical items. Certain embodiments of the present disclosure may include elements, components, and/or configurations other than those illustrated in the drawings, and some of the elements, components, and/or configurations illustrated in the drawings may not be present in certain embodiments.

FIG. 1 is a cross-sectional view of a gypsum panel.

FIG. 2 is a cross-sectional view of a gypsum panel

FIG. 3 is a cross-sectional view of a gypsum panel.

FIG. 4 is a graph showing the % shrinkage of various experimental samples subjected to a high temperature shrinkage test, according to the Examples.

FIG. 5 is a graph showing the % shrinkage of various experimental samples subjected to a high temperature core integrity test, according to the Examples.

FIG. 6 is a set of photographs showing the cross-sections of various experimental samples subjected to a high temperature core integrity test, according to the Examples.

FIG. 7 is a graph showing the % shrinkage of various experimental samples subjected to a high temperature core integrity test, according to the Examples.

FIG. 8 is a graph showing the deflection of various experimental samples subjected to a high temperature core integrity test, according to the Examples.

FIG. 9 is a graph showing the nail pull force of various experimental samples, according to the Examples.

FIG. 10 is a graph showing the % shrinkage of various experimental samples subjected to a high temperature core integrity test, according to the Examples.

FIG. 11 is a graph showing the % shrinkage of various experimental samples subjected to a high temperature core integrity test, according to the Examples.

FIG. 12 is a graph showing the flexural force of various experimental samples, according to the Examples.

FIG. 13 is a set of photographs showing the cross-sections of various experimental samples subjected to a high temperature core integrity test, according to the Examples.

### DETAILED DESCRIPTION

Gypsum panels and systems of panels, and methods for their manufacture, are provided herein. The panels may be lightweight panels and display improved physical properties as well as fire resistance. In particular, these panels contain a colloidal material in an amount effective to achieve the desired light panel weight and optionally, fire resistance and/or strength properties, as discussed in detail herein. For example, in certain embodiments, the colloidal material may be the second most prevalent component of the panel core, by weight, after the gypsum. It has been discovered that such panels may reduce the amount of costly ingredients needed to achieve fire resistance ratings in lightweight panels having the desired physical properties. In particular, the gypsum panels described herein may beneficially provide an alternative to the use of vermiculite or other fire resistant materials in gypsum panels. In other embodiments, the colloidal materials may be used in combination with vermiculite and/or other materials that provide fire resistant properties, such as perlite, clays, wollastonite, and/or diatomaceous earth, to achieve the desired properties.

Generally, this disclosure relates to the use of colloidal materials in gypsum panels to achieve a desired lightweight and fire resistant panel. As used herein, the phrase “colloidal material” refers to materials that are in the form of a stable dispersion of particles. That is, the colloidal materials are in a liquid form upon combination with other ingredients (e.g., stucco) to form a slurry from which a gypsum panel, or layer thereof, is formed. Certain embodiments of the disclosure relate to colloidal silica and colloidal alumina, although other suitable colloidal materials may also be used, such as colloidal titanium materials. For example, the colloidal materials may contain dense, amorphous particles of silicon dioxide, aluminum oxide, or another material. Such colloidal dispersions are fluid, low viscosity dispersions having particles with an average size from about 2 nm to about 150 nm, such as from about 60 nm to about 90 nm. The particles of such dispersions may be spherical or slightly irregular in shape, and may be present as discrete particles or slightly structured aggregates. In certain embodiments, the particles are present in a narrow or wide particle size range.

As described herein, various grades of colloidal materials were found to be effective to provide the desired physical properties relating to core integrity and reduced high temperature shrinkage. Dispersion concentration, particle size (e.g., specific surface area), and pH may differ between the grades of colloidal materials.

In certain embodiments, the colloidal material is a liquid form of colloidal silica having a concentration of from about 7 to about 50 percent, by weight, silicon dioxide, such as from about 20 to about 50 percent, such as from about 30 to about 50 percent, such as from about 34 to about 50 percent, such as from about 40 to about 50 percent. For example, the colloidal silica particles may have an average particle diameter in the range of about 1 to about 150 nm, such as from about 2 to about 100 nm. For example, the colloidal silica particles may have an average surface area of from about 30 to about 1,100 m²/g, such as from about 30 to about 750 m²/g, or about 50 to about 250 m²/g. For example, the colloidal silica may have a pH in the range of about 2 to about 12, depending on its chemistry. For example, pure colloidal silica formulations are anionic and may be sodium- or ammonium-stabilized to a pH of about 9 to about 11. However, as will be discussed in greater detail below, colloidal silica may have surface modification to achieve other desired properties (e.g., pH, stability, charge). For example, through modification using sodium aluminate, a colloidal silica may be stable down to a pH of about 3 to about 4. For example, cationic colloidal silica may be stable at a pH of from about 4 to about 5, and deionized colloidal silica may be stable at a low pH of about 2 to about 3. Thus, such surface modified forms of colloidal silica are intended to fall within the scope of this disclosure.

For example, modified colloidal silica forms modified with ammonium, aluminate, chloride, silane, and deionized forms are also encompasses by the term “colloidal silica” as used herein. Suitable colloidal silica formulations include those manufactured under the Levasil® brand, which are commercially available from Nouryon. For example, as discussed with reference to the examples below, Levasil® 40-58 (40% weight silicon dioxide in water), Levasil 34-720 (34% weight silicon dioxide in water), Levasil 50-28 (50% weight silicon dioxide in water), Levasil 40-620P (40% weight silicon dioxide in water), and Levasil 40-120 (40% weight silicon dioxide in water) were each shown to provide improved high temperature shrinkage and core integrity.

In certain embodiments, the colloidal material is a liquid form of colloidal alumina having a concentration of from about 7 to about 50 percent, by weight, aluminum oxide, such as from about 10 to about 40 percent, such as from about 10 to about 30 percent, such as from about 15 to about 25 percent. For example, the colloidal silica particles may have an average particle diameter in the range of about 1 to about 150 nm, such as from about 2 to about 100 nm, such as from about 60 to about 90 nm. Suitable modified forms of colloidal alumina may also be used. Suitable colloidal alumina formulations include those manufactured under the NYACOL® brand, which are commercially available from NYACOL® Nano Technologies, Inc. For example, as discussed with reference to the examples below, NYACOL® AL20 (20% weight aluminum oxide in water) was shown to provide improved high temperature shrinkage and core integrity.

Generally, this disclosure is intended to encompass various forms of gypsum panel products, such as paper-faced fire-rated panels, sheathing panels, roofing panels, and other glass mat and paper faced gypsum panels. While certain embodiments may be described with reference to the term “fire-rated” “sheathing” or “roofing”, it should be understood that the panels described herein are not meant to be limited to these particular uses, and that the features of panels described as fire-rated, sheathing or roofing panels may be encompassed by other types of gypsum panels.

Gypsum panels or boards may contain a set gypsum core sandwiched between two mats, none, one, or both of which may be coated. The mat coating may be a substantially continuous barrier coating. As used herein, the term “substantially continuous barrier coating” refers to a coating material that is substantially uninterrupted over the surface of the mat.

During manufacturing, a gypsum slurry may be deposited on the uncoated surface of a facer material, such as a paper sheet or fiberglass mat (which may be pre-coated offline or online), and set to form a gypsum core of the panel. The gypsum slurry may adhere to a paper facing material or penetrate some portion of the thickness of the fiberglass mat, and provide a mechanical bond for the panel. The gypsum slurry may be provided in one or more layers, having the same or different compositions, including one or more slate coat layers. As used herein, the term “slate coat” refers to a gypsum slurry having a higher wet density than the remainder of the gypsum slurry that forms the gypsum core.

While this disclosure is generally directed to gypsum panels, it should be understood that other cementitious panel core materials are also intended to fall within the scope of the present disclosure. For example, cementitious panel core materials such as those including magnesium oxide or aluminosilicate may be substituted for the gypsum of the embodiments disclosed herein, to achieve similar results.

Moreover, while embodiments of the present disclosure are described generally with reference to paper facing materials or fiberglass mats, it should be understood that other mat materials, including other fibrous mat materials, may also be used in the present panels. In certain embodiments, the nonwoven fibrous mat is formed of fiber material that is capable of forming a strong bond with the material of the building panel core through a mechanical-like interlocking between the interstices of the fibrous mat and portions of the core material. Examples of fiber materials for use in the nonwoven mats include mineral-type materials such as glass fibers, synthetic resin fibers, and mixtures or blends thereof. Both chopped strands and continuous strands may be used.

Various embodiments of this disclosure are for purposes of illustration only. Parameters of different steps, components, and features of the embodiments are described separately, but may be combined consistently with this description of claims, to enable other embodiments as well to be understood by those skilled in the art. Various terms used herein are likewise defined in the description, which follows.

Methods

Methods of making gypsum panels containing colloidal materials are provided. In particular, these methods may include forming a first gypsum slurry by combining stucco, water, and a colloidal material including colloidal silica, colloidal alumina, or both, and setting the first gypsum slurry to form at least part of a core of the gypsum panel. In certain embodiments, the colloidal material is present in the gypsum core in an amount, by weight, greater than any other component, other than the gypsum. That is, the colloidal material, or the particles remaining therefrom after the gypsum panel is set, may be present in an amount that is greater than all other ingredients in the gypsum core, other than the gypsum. For example, the colloidal material in its liquid dispersion form may be present in the relevant gypsum slurry (i.e., the slurry from which the entire gypsum core, or merely a layer thereof, is formed) in an amount greater, by weight, than all ingredients other than gypsum, except processing ingredients such as water, soap, foaming agent, and the like. In certain embodiments, the colloidal material is present in the gypsum panel in an amount effective to produce an average percent shrinkage of less than 4%, such as from about 0.1% to about 4% shrinkage, when measured by the High Temperature Shrinkage Test, as outlined in ASTM C1795-15: Standard Test Methods for High-Temperature Characterization of Gypsum Boards and Panels.

For example, the colloidal material may be present in the gypsum core in an amount of about 1 lb/msf to about 300 lb/msf, for a gypsum panel having a thickness of about ¼ inch to about 1 inch. For example, the colloidal material may be present in the gypsum core in an amount of about 1 lb/msf to about 200 lb/msf, for a gypsum panel having a thickness of about ¼ inch to about 1 inch. For example, the colloidal material may be present in the gypsum core in an amount of about 10 lb/msf to about 300 lb/msf, such as in an amount of about 10 lb/msf to about 200 lb/msf, about 10 lb/msf to about 70 lb/msf, about 50 lb/msf to about 150 lb/msf, about 70 lb/msf to about 140 lb/msf, or about 75 lb/msf to about 125 lb/msf, for a gypsum panel having a thickness of about ¼ inch to about 1 inch. As used herein, “msf” refers to 1,000 square feet.

In certain embodiments, the colloidal material may not be the second most prevalent component, by weight. For example, in certain panels containing a starch, such as a pregelatinized starch, and/or a polyphosphate, such as sodium trimetaphosphate, one or more of those components may be present in an amount close to or greater than the amount of colloidal material, by weight. For example, in panel core compositions containing relatively low amounts of colloidal materials, such as 40 lb/msf or less (e.g., 20 lb/msf or less, or 10 lb/msf or less), the amount of one or more functional additives, such as starch or polyphosphate may be close to or greater than the amount of the colloidal material, such as from 10 lb/msf to 40 lb/msf. Additional examples of such materials and possible amounts of such materials within exemplary panels are provided below. It should be understood that the disclosed amounts of ingredients may be combined in any possible combination provided by the disclosed ingredients and amounts and such combinations are intended to fall within the scope of this disclosure.

For example, the colloidal material may be present in the gypsum core or a layer thereof in a ratio of colloidal material to gypsum stucco of from about 100:1500 to about 15:1500, such as from about 35:1500 to about 70:1500.

The panel thickness ranges given herein are meant to be exemplary, and it should be understood that panels in accordance with the present disclosure may have any suitable thickness. Where amounts of materials present within the panel are defined in terms of lb/msf over a certain thickness of panel, it should be understood that the amount of the relevant material described to be present per volume of the panel may be applied to various other panel thicknesses. In certain embodiments, the panels have a thickness from about ¼ inch to about 1 inch. For example, the panels may have a thickness of from about ½ inch to about ⅝ inch, such as from about ½ inch to about %, as generally described.

As used herein the term “about” is used to refer to plus or minus 2 percent of the relevant numeral that it describes. These methods may be used to produce gypsum panels having any of the features, or combinations of features, described herein, such as improved physical properties, such as strength properties, and fire resistance.

In certain embodiments, the colloidal material may have a particle size/specific surface area and/or dispersion concentration that is effective to achieve the desired physical properties of the gypsum board. For example, as discussed above, the colloidal material may be colloidal silica, containing silicon dioxide, such as amorphous silicon dioxide in the concentrations mentioned above, e.g., about 7 percent by weight to about 50 percent by weight, or may be colloidal alumina, containing aluminum oxide, such as amorphous aluminum oxide in the concentrations mentioned above. The colloidal silica or alumina may have an average particle diameter of from about 1 nm to about 100 nm and/or an average particle surface area of from about 30 to about 1,100 m²/g. For example, the colloidal silica or alumina may have a pH of from about 2 to about 12.

In certain embodiments, the gypsum slurries of the present disclosure further contain one or more ingredients or additives to achieve the desired board properties. Various additives are discussed herein and may be used in any combination. In particular, suitable additives may include, but are not limited to, one or more of starch, fiberglass, dispersants, ball mill accelerators, retarders, potash, polyphosphates, and polymer binders.

For example, a suitable polyphosphate may be contained in the gypsum slurry. For example, the polyphosphate may be sodium trimetaphosphate (STMP), sodium hexametaphosphate (SHMP), ammonium polyphosphate (APP). Other suitable phosphate salts may also be used and include other metaphosphate, polyphosphate, and pyrophosphate salts, such as ammonium trimetaphosphate, potassium trimetaphosphate, lithium trimetaphosphate, calcium trimetaphosphate, sodium calcium trimetaphosphate, aluminum trimetaphosphate; ammonium, lithium, or potassium hexametaphosphates; sodium tripolyphosphate, potassium tripolyphosphate, sodium and potassium tripolyphosphate; calcium pyrophosphate, tetrapotassium pyrophosphate, and/or tetrasodium pyrophosphate.

For example, a suitable starch may be contained in the gypsum slurry in an amount effective to bind the gypsum to the colloidal material. For example, the starch may act as a binder for binding the gypsum to the colloidal material, or the gypsum to a colloidal material and vermiculite mixture, if used. The starch may be any suitable starch material known in the industry. In some embodiments, the starch is pregelatinized (precooked) starch or a combination of uncooked and pregelatinized starch. For example, the starch may be present in the gypsum core in an amount of about 1 lb/msf to about 70 lb/msf, for a gypsum panel having a thickness of about ¼ inch to about 1 inch, such as from about 1 lb/msf to about 50 lb/msf, such as from about 10 lb/msf to about 40 lb/msf.

For example, a suitable polymer binder, such as an organic polymer binder may be contained in the gypsum slurry. Suitable polymer binders may include polymeric emulsions and resins, e.g., acrylics, siloxane, silicone, styrene-butadiene copolymers, polyethylene-vinyl acetate, polyvinyl alcohol, polyvinyl chloride (PVC), polyurethane, urea-formaldehyde resin, phenolics resin, polyvinyl butyryl, styrene-acrylic copolymers, styrene-vinyl-acrylic copolymers, styrene-maleic anhydride copolymers. In some embodiments, the binders may include UV curable monomers and polymers (e.g., epoxy acrylate, urethane acrylate, polyester acrylate). For example, on a dry basis, the polymer binder content may be between 1 lb/msf to 50 lb/msf, for a gypsum panel having a thickness of about ¼ inch to 1 inch.

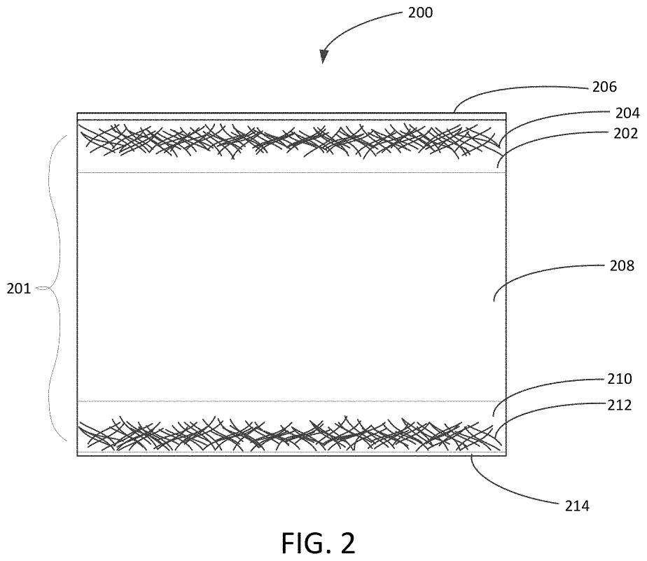

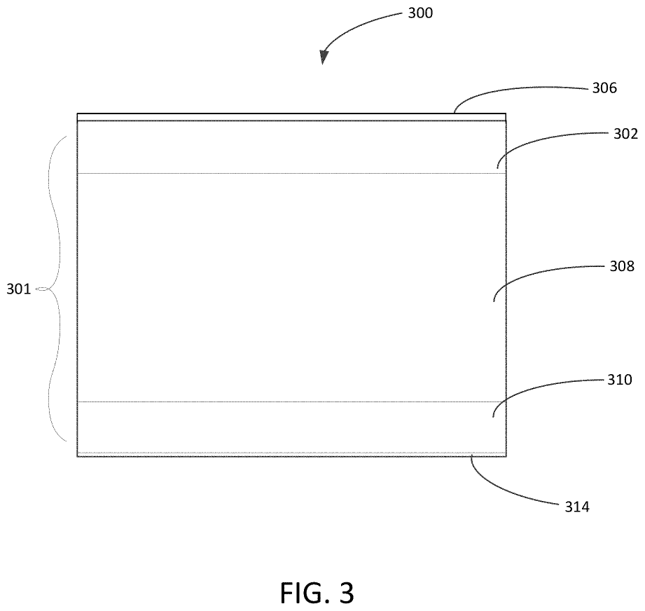

In certain embodiments, the gypsum core includes multiple layers that are sequentially applied to a facing material, and allowed to set either sequentially or simultaneously. In such embodiments, the first gypsum slurry may form any one or more of these layers. In other embodiments, the gypsum core includes a single layer formed by the first gypsum slurry. In some embodiments, a second facing material may be deposited onto a surface of the final gypsum slurry layer (or the sole gypsum slurry layer), to form a dual mat-faced gypsum panel, as shown in FIGS. 2 and 3. In certain embodiments, the first gypsum slurry (or each of the outermost gypsum slurry layers) is deposited in an amount of from about 5 percent to about 20 percent, by weight, of the gypsum core. The gypsum slurry or multiple layers thereof may be deposited on the facer material by any suitable means, such as roll coating.

In certain embodiments, the first gypsum slurry (or other gypsum slurry layers that form the core) contains one or more additional agents to enhance its performance, such as, but not limited to, wetting agents, moisture resistance agents, fillers, accelerators, set retarders, foaming agents, polyphosphates, and dispersing agents. Various example uses of such further additives will now be described.

In certain embodiments, a wetting agent is selected from a group consisting of surfactants, superplasticisers, dispersants, agents containing surfactants, agents containing superplasticisers, agents containing dispersants, and combinations thereof. For example, suitable superplasticisers include Melflux 2651 F and 4930F, commercially available from BASF Corporation. In certain embodiments, the wetting agent is a surfactant having a boiling point of 200° C. or lower. In some embodiments, the surfactant has a boiling point of 150° C. or lower. In some embodiments, the surfactant has a boiling point of 110° C. or lower. For example, the surfactant may be a multifunctional agent based on acetylenic chemistry or an ethoxylated low-foam agent.

In certain embodiments, a surfactant is present in the relevant gypsum slurry in an amount of about 0.01 percent to about 1 percent, by weight. In certain embodiments, the surfactant is present in the relevant gypsum slurry in an amount of about 0.01 percent to about 0.5 percent, by weight. In some embodiments, the surfactant is present in the relevant gypsum slurry in an amount of about 0.05 percent to about 0.2 percent, by weight.

Suitable surfactants and other wetting agents may be selected from non-ionic, anionic, cationic, or zwitterionic compounds, such as alkyl sulfates, ammonium lauryl sulfate, sodium lauryl sulfate, alkyl-ether sulfates, sodium laureth sulfate, sodium myreth sulfate, docusates, dioctyl sodium sulfosuccinate, perfluorooctanesulfonate, perfluorobutanesulfonate, linear alkylbenzene sulfonates, alkyl-aryl ether phosphates, alkyl ether phosphate, alkyl carboxylates, sodium stearate, sodium lauroyl sarcosinate, carboxylate-based fluorosurfactants, perfluorononanoate, perfluorooctanoate, amines, octenidine dihydrochloride, alkyltrimethylammonium salts, cetyl trimethylammonium bromide, cetyl trimethylammonium chloride, cetylpyridinium chloride, benzalkonium chloride, benzethonium chloride, 5-Bromo-5-nitro-1,3-dioxane, dimethyldioctadecylammonium chloride, cetrimonium bromide, dioctadecyldimethylammonium bromide, sultaines, cocamidopropyl hydroxysultaine, betaines, cocamidopropyl betaine, phospholipids phosphatidylserine, phosphatidylethanolamine, phosphatidylcholine, sphingomyelins, fatty alcohols, cetyl alcohol, stearyl alcohol, cetostearyl alcohol, stearyl alcohols. oleyl alcohol, polyoxyethylene glycol alkyl ethers, octaethylene glycol monododecyl ether, pentaethylene glycol monododecyl ether, polyoxypropylene glycol alkyl ethers, glucoside alkyl ethers, polyoxyethylene glycol octylphenol ethers, polyoxyethylene glycol alkylphenol ethers, glycerol alkyl esters, polyoxyethylene glycol sorbitan alkyl esters, sorbitan alkyl esters, cocamide MEA, cocamide DEA, dodecyldimethylamine oxide, polyethoxylated tallow amine, and block copolymers of polyethylene glycol and polypropylene glycol. For example, suitable surfactants include Surfynol 61, commercially available from Air Products and Chemicals, Inc. (Allentown, Pa.).

In certain embodiments, a moisture resistance or hydrophobizing agent is provided in the gypsum slurry or layers thereof to impart desired moisture resistance and/or processing properties to the panel. For example, the moisture resistance or hydrophobizing agent may include a wax, wax emulsions or co-emulsions, silicone, siloxane, siliconate, or any combination thereof. In certain embodiments, a moisture resistance or hydrophobizing agent is present in the relevant gypsum slurry in an amount of about 0.01 percent to about 1 percent, by weight. In certain embodiments, the moisture resistance or hydrophobizing agent is present in the relevant gypsum slurry in an amount of about 0.01 percent to about 0.5 percent, by weight. In some embodiments, the moisture resistance or hydrophobizing agent is present in the relevant gypsum slurry in an amount of about 0.05 percent to about 0.2 percent, by weight.

In certain embodiments, the gypsum slurry (or one or more layers thereof) is substantially free of foam, honeycomb, excess water, and micelle formations. As used herein, the term “substantially free” refers to the slurry containing lower than an amount of these materials that would materially affect the performance of the panel. That is, these materials are not present in the slurry in an amount that would result in the formation of pathways for liquid water in the glass mat of a set panel, when under pressure.

In certain embodiments, the panel core slurry (or layers thereof) may be deposited on a horizontally oriented moving web of facer material, such as pre-coated fibrous mat or paper facing material. A second coated or uncoated web of facer material may be deposited onto the surface of the panel core slurry opposite the first web of facer material, e.g., a non-coated surface of the second web of facer material contacts the panel core slurry. In some embodiments, a moving web of a facer material may be placed on the upper free surface of the aqueous panel core slurry. Thus, the panel core material may be sandwiched between two facer materials, none, one or both having a coating. In certain embodiments, allowing the panel core material and/or coating to set includes curing, drying, such as in an oven or by another suitable drying mechanism, or allowing the material(s) to set at room temperature (i.e., to self-harden).

A barrier coating may be applied to one or both (in embodiments having two) facer surfaces, prior to or after drying of the facers. In some embodiments, the glass mats are pre-coated when they are associated with the panel core slurry. In some embodiments, depositing a barrier coating onto the second surface of the first coated glass mat occurs after setting the first gypsum slurry to form at least a portion of a gypsum core. In some embodiments, the gypsum core coated with the barrier coating is cured, dried, such as in an oven or by another suitable drying mechanism, or the materials are allowed to set at room temperature. In some embodiment, infrared heating is used to flash off water and dry the barrier coating.

Suitable coating materials (i.e., the precursor to the dried mat coating) may contain at least one suitable polymer binder. Suitable polymer binders may be selected from polymeric emulsions and resins, e.g. acrylics, siloxane, silicone, styrene-butadiene copolymers, polyethylene-vinyl acetate, polyvinyl alcohol, polyvinyl chloride (PVC), polyurethane, urea-formaldehyde resin, phenolics resin, polyvinyl butyryl, styrene-acrylic copolymers, styrene-vinyl-acrylic copolymers, styrene-maleic anhydride copolymers. In some embodiments, the polymer binder is an acrylic latex or a polystyrene latex. In some embodiments, the polymer binder is hydrophobic. In certain embodiments, the binder includes UV curable monomers and/or polymers (e.g. epoxy acrylate, urethane acrylate, polyester acrylate). In certain embodiments, the mat coating contains the polymer binder in an amount of from about 5 percent to about 75 percent, by weight, on a dry basis.

Examples of suitable polymer binders that may be used in the continuous barrier coatings described herein include SNAP 720, commercially available from Arkema Coating Resins, which is a structured nano-particle acrylic polymer containing 100% acrylic latex and 49% solids by weight, with a 0.08 micron particle size; SNAP 728, commercially available from Arkema Coating Resins, which is a structured nano-acrylic polymer containing 100% acrylic latex and 49% solids by weight, with a 0.1 micron particle size; and NEOCAR 820, commercially available from Arkema Coating Reins, which is a hydrophobic modified acrylic latex containing 45% solids by weight, with a 0.07 micron particle size.

In certain embodiments, the mat coating also contains one or more inorganic fillers. For example, the inorganic filler may be calcium carbonate or another suitable filler known in the industry. In certain embodiments, the filler is an inorganic mineral filler, such as ground limestone (calcium carbonate), clay, mica, gypsum (calcium sulfate dihydrate), aluminum trihydrate (ATH), antimony oxide, sodium-potassium alumina silicates, pyrophyllite, microcrystalline silica, and talc (magnesium silicate). In certain embodiments, the filler may inherently contain a naturally occurring inorganic adhesive binder. For example, the filler may be limestone containing quicklime (CaO), clay containing calcium silicate, sand containing calcium silicate, aluminum trihydrate containing aluminum hydroxide, cementitious fly ash, or magnesium oxide containing either the sulfate or chloride of magnesium, or both. In certain embodiments, the filler may include an inorganic adhesive binder as a constituent, cure by hydration, and act as a flame suppressant. For example, the filler may be aluminum trihydrate (ATH), calcium sulfate (gypsum), and the oxychloride and oxysulfate of magnesium. For example, fillers may include MINEX 7, commercially available from the Cary Company (Addison, Ill.); IMSIL A-10, commercially available from the Cary Company; and TALCRON MP 44-26, commercially available from Specialty Minerals Inc. (Dillon, Mont.). The filler may be in a particulate form. For example, the filler may have a particle size such that at least 95% of the particles pass through a 100 mesh wire screen.

In certain embodiments, the precursor material that forms the mat coating also contains water. For example, the coating material may contain the polymer binder in an amount of from about 35 percent to about 80 percent, by weight, and water in an amount of from about 20 percent to about 30 percent, by weight. In embodiments containing the filler, the continuous barrier coating material may also contain an inorganic filler in an amount of from about 35 percent to about 80 percent, by weight. In some embodiments, the polymer binder and the inorganic filler are present in amounts of within 5 percent, by weight, of each other. For example, the polymer binder and filler may be present in a ratio of approximately 1:1.

In some embodiments, the mat coating also includes water and/or other optional ingredients such as colorants (e.g., dyes or pigments), transfer agents, thickeners or rheological control agents, surfactants, ammonia compositions, defoamers, dispersants, biocides, UV absorbers, and preservatives. Thickeners may include hydroxyethyl cellulose; hydrophobically modified ethylene oxide urethane; processed attapulgite, a hydrated magnesium aluminosilicate; and other thickeners known to those of ordinary skill in the art. For example, thickeners may include CELLOSIZE QP-09-L and ACRYSOL RM-2020NPR, commercially available from Dow Chemical Company (Philadelphia, Pa.); and ATTAGEL 50, commercially available from BASF Corporation (Florham Park, N.J.). Surfactants may include sodium polyacrylate dispersants, ethoxylated nonionic compounds, and other surfactants known to those of ordinary skill in the art. For example, surfactants may include HYDROPALAT 44, commercially available from BASF Corporation; and DYNOL 607, commercially available from Air Products (Allentown, Pa.). Defoamers may include multi-hydrophobe blend defoamers and other defoamers known to those of ordinary skill in the art. For example, defoamers may include FOAMASTER SA-3, commercially available from BASF Corporation. Ammonia compositions may include ammonium hydroxide, for example, AQUA AMMONIA 26 BE, commercially available from Tanner Industries, Inc. (Southampton, Pa.). Biocides may include broad-spectrum microbicides that prohibit bacteria and fungi growth, antimicrobials such as those based on the active diiodomethyl-p-tolylsulfone, and other compounds known to those of ordinary skill in the art. For example, biocides may include KATHON LX 1.5%, commercially available from Dow Chemical Company, POLYPHASE 663, commercially available from Troy Corporation (Newark, N.J.), and AMICAL Flowable, commercially available from Dow Chemical Company. Biocides may also act as preservatives. UV absorbers may include encapsulated hydroxyphenyl-triazine compositions and other compounds known to those of ordinary skill in the art, for example, TINUVIN 477DW, commercially available from BASF Corporation. Transfer agents such as polyvinyl alcohol (PVA) and other compounds known to those of ordinary skill in the art may also be included in the coating composition.

In certain embodiments, the gypsum panels described herein are “lightweight” panels, having a core density of no more than about 40 pcf (lb/ft³). For example, in some embodiments, the panel has a panel weight of from about 800 to about 2500 lb/msf, such as from about 800 to about 2000 lb/msf, such as from about 800 to about 1600 lb/msf, such as from about 800 to about 1300 lb/msf, for a gypsum panel having a thickness of about ¼ inch to about 1 inch.

These panels may be relatively lightweight while also providing a high fire resistance level, but without the use of, or using a lower relative amount of, vermiculite. For example, the boards described herein may display similar or better thermal shrinkage and high temperature core integrity results than comparative boards containing vermiculite, such as measured according to ASTM C1795-15: Standard Test Methods for High-Temperature Characterization of Gypsum Boards and Panels. Further, the panels containing colloidal materials such as silica and alumina were discovered to display less sag, under fire resistance testing, than a comparable board made with vermiculite.

Methods of constructing a building sheathing system are also provided herein, including installing at least two gypsum panels having an interface therebetween, and applying a seaming component at the interface between the at least two of the gypsum panels. Gypsum panels used in these methods may have any of the features, properties, or combinations of features and/or properties, described herein. Sheathing systems constructed by these methods may have any of the features, properties, or combinations or features and/or properties, described herein. The seaming component may be any suitable seaming component as described herein.

Panels and Systems

Gypsum panels having improved fire resistance and/or physical properties may be made by any of the methods described herein. For example, a gypsum panel may include a gypsum core containing set gypsum and a colloidal material including colloidal silica, colloidal alumina, or both, wherein the colloidal material is present in the gypsum core in an amount greater than any other component, other than the gypsum. As discussed above, the panels may have a thickness from about ¼ inch to about 1 inch. For example, the panels may have a thickness of from about ½ inch to about ⅝ inch.

In certain embodiments, as shown in FIG. 3, a gypsum panel 300 includes one or two paper facer materials 306, 314 that are associated with the gypsum core 301. The second facer 314 is present on a face of the gypsum core 301 opposite the first facer 306. In some embodiments, one or both of the facer materials 306, 314 may have a coating disposed on one or both surfaces thereof, prior to combination with the gypsum slurry, or, for external surface coatings, after combination with the gypsum slurry. In some embodiments, the gypsum core 301 includes three gypsum layers 302, 308, 310. One or both of the gypsum layers 302, 310 that are in contact with the facers 306, 314 may be a slate coat layer, as discussed herein.

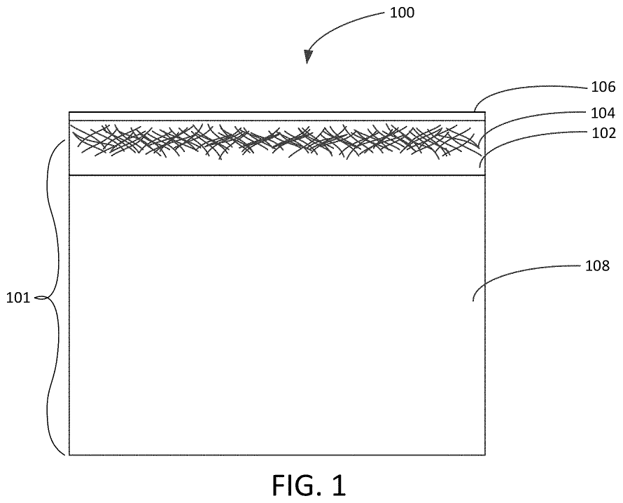

In some embodiments, as shown in FIG. 1, the gypsum of the gypsum core 101 penetrates a remaining portion of the first fibrous mat 104 such that voids in the mat 104 are substantially eliminated. For example, in one embodiment, the first mat 104 has a mat coating 106 on a surface opposite the gypsum core 101, the mat coating 106 penetrating a portion of the first mat 104, to define the remaining portion of the first mat 104. That is, gypsum of the gypsum core 101 may penetrate a remaining fibrous portion of the first fibrous mat 104 such that voids in the first mat 104 are substantially eliminated. As used herein the phrase “such that voids in the mat are substantially eliminated” and similar phrases, refer to the gypsum slurry, and thus the set gypsum, of the gypsum core filling all or nearly all of the interstitial volume of the fibrous mat that is not filled by the coating material. In certain embodiments, the gypsum of the gypsum core fills at least 95 percent of the available interstitial volume of the mat. In some embodiments, the gypsum core fills at least 98 percent of the available interstitial volume of the mat. In further embodiments, the gypsum core fills at least 99 percent of the available interstitial volume of the mat.

By maximizing gypsum slurry penetration into the side of the mat receiving gypsum, the movement of water under the mat coating within the glass mat of the finished panel when exposed to bulk water head pressures may be substantially and adequately reduced, without significantly altering the water vapor transmission rate (i.e., the ability to dry) of the finished panel. Thus, the gypsum panels disclosed herein may further display one or more improved water-resistive barrier properties.

In certain embodiments, the mat 104 is a nonwoven fiberglass mat. For example, the glass fibers may have an average diameter of from about 10 to about 17 microns and an average length of from about ¼ inch to about 1 inch. For example, the glass fibers may have an average diameter of 13 microns (i.e., K fibers) and an average length of % inch. In certain embodiments, the nonwoven fiberglass mats have a basis weight of from about 1.5 pounds to about 6.0 pounds per 100 square feet of the mat, such as from about 1.5 pounds to about 3.5 pounds per 100 square feet of the mat. The mats may each have a thickness of from about 20 mils to about 35 mils. The fibers may be bonded together to form a unitary mat structure by a suitable adhesive. For example, the adhesive may be a urea-formaldehyde resin adhesive, optionally modified with a thermoplastic extender or cross-linker, such as an acrylic cross-linker, or an acrylate adhesive resin. In other embodiments, the mat facer may be a suitable paper facer material.

In certain embodiments, as shown in FIG. 1, the gypsum core 101 includes two or more gypsum layers 102, 108. For example, the gypsum core may include various gypsum layers having different compositions. In some embodiments, the first gypsum layer 102 that is in contact with the mat 104 (i.e., the layer that forms an interface with the coating material 106 and at least partially penetrates the first mat) is a slate coat layer. In some embodiments, the first gypsum layer 102 is present in an amount from about 5 percent to about 20 percent, by weight, of the gypsum core 101. In certain embodiments, the slate coat layer is formed from the first gypsum slurry described herein. In other embodiments, the entire panel core is formed from the first gypsum slurry. The first gypsum slurry may form one or more of these layers.

In certain embodiments, as shown in FIG. 2, a gypsum panel 200 includes two fibrous mats 204, 212 (which could alternatively be paper facers) that are associated with the gypsum core 201. The second mat 212 is present on a face of the gypsum core 201 opposite the first mat 204. In some embodiments, only the first mat 204 has a mat coating 206 on a surface thereof. In other embodiments, both mats 204, 212 have a coating 206, 214 on a surface thereof opposite the gypsum core 201. In some embodiments, the gypsum core 201 includes three gypsum layers 202, 208, 210. One or both of the gypsum layers 202, 210 that are in contact with the mats 204, 212 may be a slate coat layer.

In certain embodiments, one or more layers of the gypsum core also includes reinforcing fibers, such as chopped fiberglass fibers or particles. In one embodiment, the gypsum core contains about 1 pound to about 20 pounds of reinforcing fibers per 1000 square feet of panel. For example, the gypsum core, or any layer(s) thereof, may include up to about 6 pounds of reinforcing fibers per 1000 square feet of panel. For example, the gypsum core, or a layer thereof, may include about 3 pounds of reinforcing fibers per 1000 square feet of panel. The reinforcing fibers may have a diameter between about 10 and about 17 microns and have a length between about 5 and about 18 millimeters.

In certain embodiments, as discussed above, the building panels described herein may display one or more improved performance characteristics such as fire resistance. Building sheathing systems are also provided herein, and include at least two of the improved water-resistive gypsum panels described herein, including any features, or combinations of features, of the panels described herein.

In certain embodiments, a building sheathing system includes at least two gypsum panels and a seaming component configured to provide a seam at an interface between at least two of the gypsum panels. In certain embodiments, the seaming component comprises tape or a bonding material. For example, the seaming component may be a tape including solvent acrylic adhesives, a tape having a polyethylene top layer with butyl rubber adhesive, a tape having an aluminum foil top layer with butyl rubber adhesive, a tape having an EPDM top layer with butyl rubber adhesive, a tape having a polyethylene top layer with rubberized asphalt adhesive, or a tape having an aluminum foil top layer with rubberized asphalt adhesive or rubberized asphalt adhesives modified with styrene butadiene styrene. For example, the seaming component may be a bonding material containing silyl terminated polyether, silyl modified polymers, silicones, synthetic stucco plasters and/or cement plasters, synthetic acrylics, sand filled acrylics, and/or joint sealing chemistries comprising solvent based acrylics, solvent based butyls, latex (water-based, including EVA, acrylic), polysulfides polyurethanes, and latexes (water-based, including EVA, acrylic).

Thus, the above-described enhanced panels may be installed with either a tape, liquid polymer, or other suitable material, to effectively treat areas of potential water and air intrusion, such as seams, door/window openings, penetrations, roof/wall interfaces, and wall/foundation interfaces.

### EXAMPLES

Embodiments of the gypsum panels disclosed herein were constructed and tested, as described below.

First, ⅝ inch paper-faced gypsum board samples were prepared containing various amounts and particle sizes of colloidal silica or colloidal alumina. The samples were tested according to the High Temperature Shrinkage Test, as outlined in ASTM C1795-15: Standard Test Methods for High-Temperature Characterization of Gypsum Boards and Panels, as well as High Temperature Core Integrity Tests, which are used to characterize the fire retardant properties of a sample. The High Temperature Core Integrity Test involves heating conditioned sample boards in an oven for an hour to a pre-determined temperature, allowing the samples to cool, then visually assessing the damage to the panel core, measuring the width, height, and length of the sample at consistent points on the sample board, and weighing the samples. The % shrinkage is then determined for the width and length measurements.

Experimental samples were prepared according to the formulations in Tables 1 and 2 below, depending on the amount of colloidal material contained in the sample. For example, the formulation of Table 1 was tested using colloidal silica at various concentrations and particle sizes, including Levasil® 40-58 (40% weight silicon dioxide in water) (all Levasil® products commercially available from Nouryon) and Levasil 34-720 (34% weight silicon dioxide in water). For example, the formulation of Table 2 was tested using colloidal silica at various concentrations and particle sizes, including Levasil 40-58 (40% weight silicon dioxide in water), Levasil 34-720 (34% weight silicon dioxide in water), Levasil 50-28 (50% weight silicon dioxide in water), and Levasil 40-620P (40% weight silicon dioxide in water), and Levasil 40-120 (40% weight silicon dioxide in water). Further, samples containing Levasil 40-58 at a 15 lb/msf full panel load rate were prepared as 350-pound experimental sample panels. Comparative samples containing 70 lb/msf and 35 lb/msf vermiculite (G5) instead of the colloidal silica were also prepared. Additionally, a control sample containing to colloidal material or vermiculite was prepared. Three samples of each tested formulation were prepared and tested according to the methods described above.

TABLE 1
Experimental Sample Formulation

| | Full Panel | | Experimental |
|---|---|---|---|
| | Amount (lb/msf) | % | Sample (lb/msf) |
| Stucco | 1500 | 94.76 | 331.65 |
| Starch | 10 | 0.63 | 2.21 |
| Vermiculite | 0 | 0 | 0 |
| Colloidal Silica | 70 | 4.42 | 15.48 |
| Fiberglass | 3 | 0.19 | 0.63 |
| Total | 1583 | 100 | 349.34 |
| Water | 1320 | — | 291.85 |
| W/S Ratio | 0.88 | — | |
| Soap | 0 | 0 | 14 |

TABLE 2
Experimental Sample Formulation

| | Full Panel | | Experimental |
|---|---|---|---|
| | Amount (lb/msf) | % | Sample (lb/msf) |
| Stucco | 1500 | 96.90 | 339.15 |
| Starch | 10 | 0.65 | 2.26 |
| Vermiculite | 0 | 0 | 0 |
| Colloidal Silica | 35 | 2.26 | 7.91 |
| Fiberglass | 3 | 0.19 | 0.66 |
| Total | 1548 | 100 | 349.32 |
| Water | 1320 | — | 298.45 |
| W/S Ratio | 0.88 | — | |
| Soap | 0 | 0 | 14 |

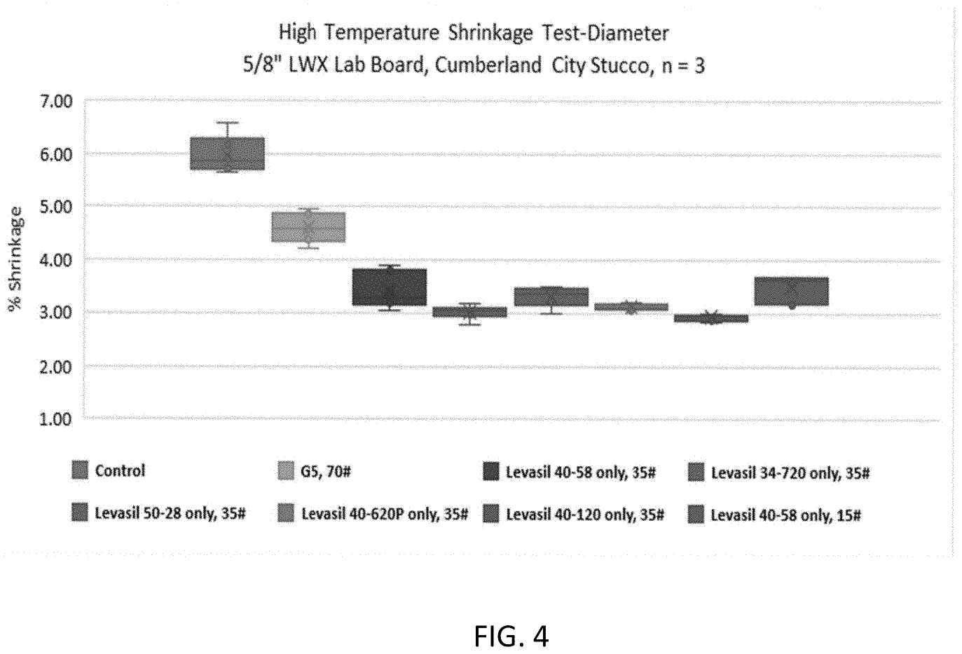

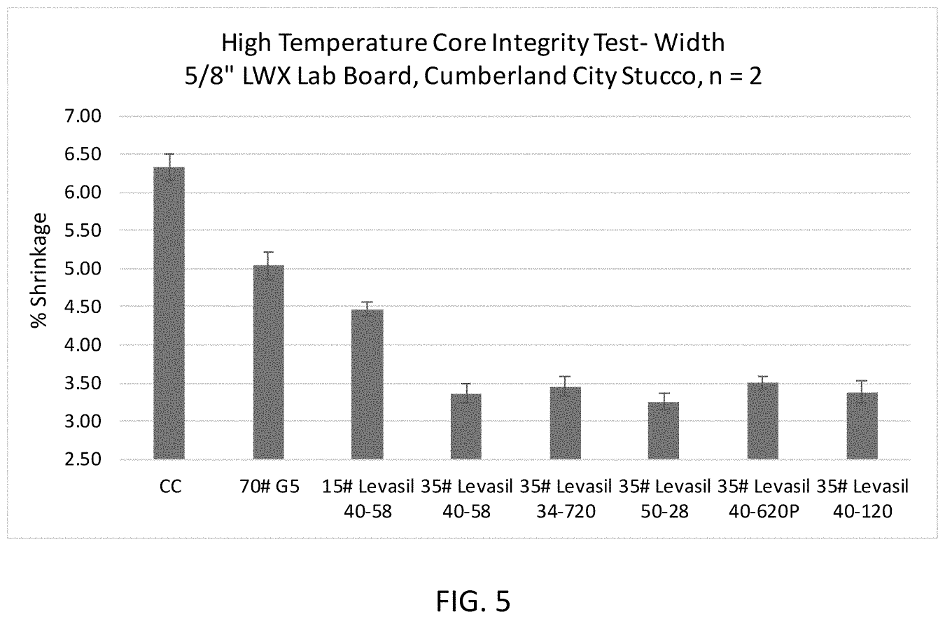

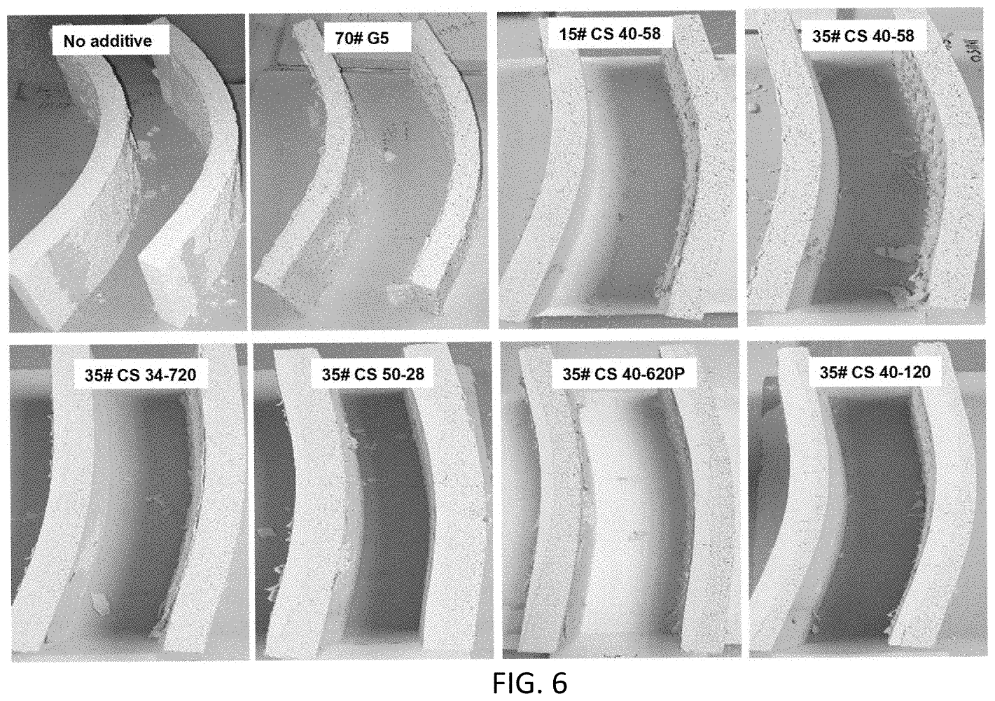

The results of the High Temperature Shrinkage Test and High Temperature Core Integrity Test can be seen in FIGS. 4 and 5 and photographs of some of the test samples after testing are presented in FIG. 6.

First, it was observed that sample panels containing the 70 lb/msf full panel load rate for colloidal silica (i.e., Table 1 formulations) were effective at reducing the amount of shrinkage, relative to the control and 70 lb/msf vermiculite load samples, for both the high temperature shrinkage and core integrity tests. Next, the amount of colloidal silica was decreased to 35 lb/msf full panel load (i.e., Table 2 formulations). Generally, these are the results shown in FIGS. 4 and 5. It was discovered that even at the 35 lb/msf load rate for at 1500 lb/msf panel, the samples containing colloidal silica outperformed the vermiculite control (70 lb/msf vermiculite), at half the load of colloidal silica, at various suspension concentrations and particle sizes. Next, samples were prepared with a 15 lb/msf load rate of colloidal silica, which results are also shown in FIGS. 4 and 5. As can be seen, even the 15 lb/msf colloidal silica panels outperformed the 70 lb/msf vermiculite control, but did not perform as well as the 35 lb/msf colloidal silica loaded samples. Thus, it has surprisingly been discovered that a significantly lower amount of colloidal silica is effective to produce lightweight, high performance gypsum boards that are similar or better than otherwise identical boards containing up to double the amount of vermiculite. FIG. 6 shows photographs of cross-sections of the sample board panels subjected to the High Temperature Core Integrity Test.

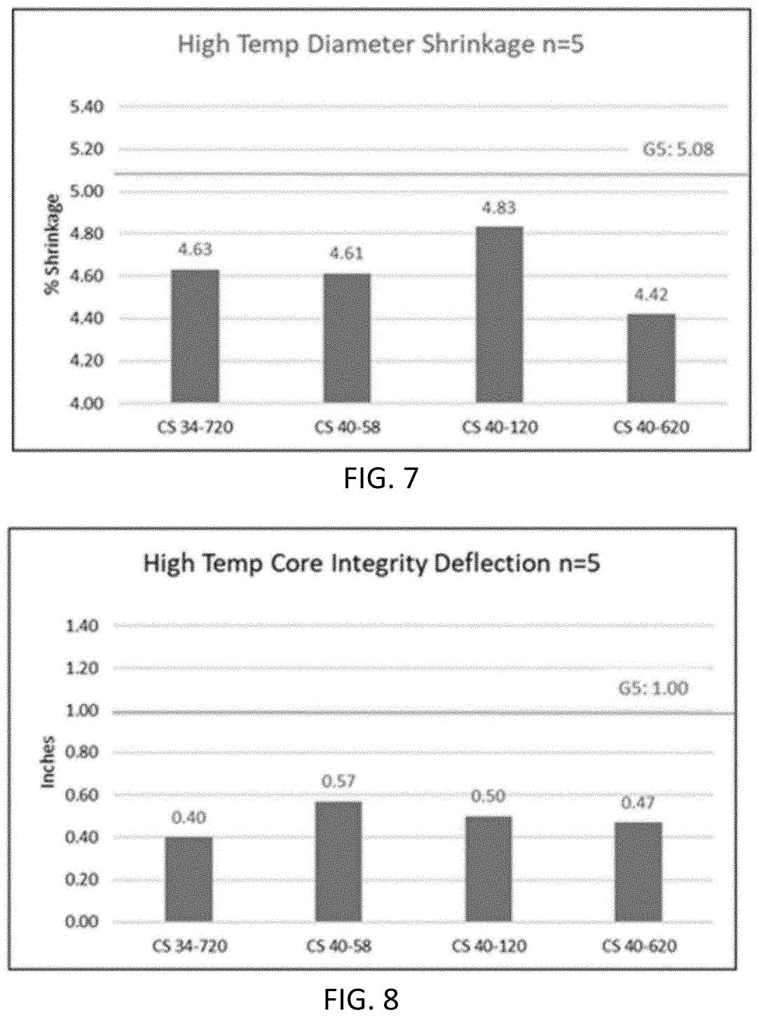

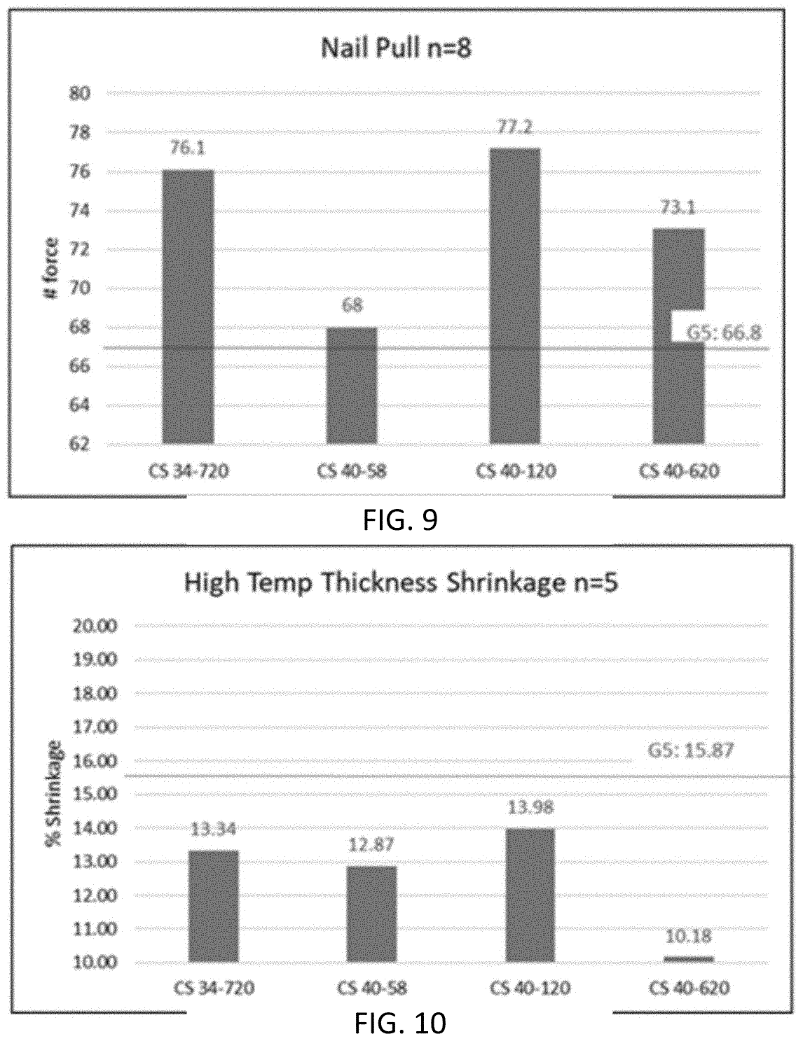

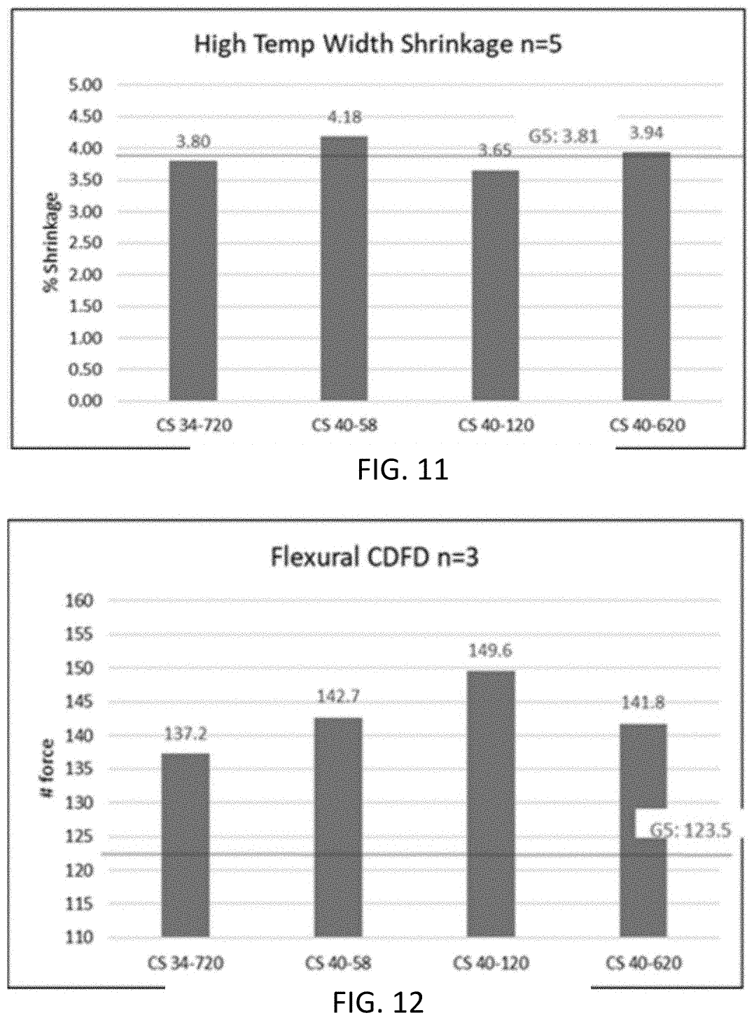

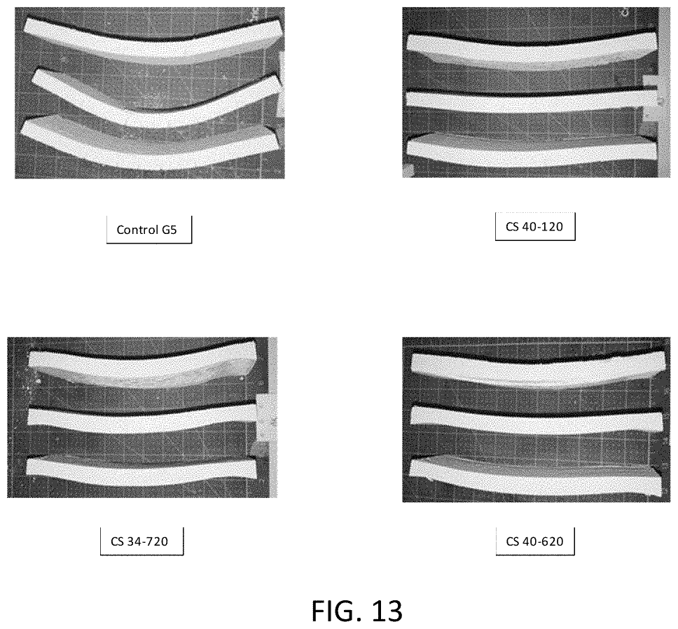

FIGS. 7-13 relate to further testing of samples containing colloidal silica at a lower colloidal silica load amount of 10 lb/msf. Four colloidal silica compositions were tested (Levasil® 34-720, Levasil 40-58, Levasil 40-120, and Levasil 40-620, which are described above). Control samples containing vermiculite (G5) were also prepared. FIGS. 7, 10, and 11 show the results of the High Temperature Shrinkage Test. FIG. 8 shows the results of the High Temperature Core Integrity Deflection Test. FIGS. 9 and 12 show the results of nail pull and flexural strength tests, performed according to ASTM C 1396/C 1396M-01. As can be seen, even at these lower colloidal silica load amounts, each sample outperforms the vermiculite control. Moreover, these samples unexpectedly display a 15-20% improvement in strength properties and were observed to display enhanced rigidity and improved score and snap properties. Indeed, the flexural strength and nail pull test results outperformed the control for all samples. The samples display significantly less average deflection under high heat versus the control in floor and ceiling testing, as can be seen in the photographs of FIG. 13. Additionally, the samples containing colloidal silica were found to maintain greater board integrity after the tests, as compared to the control. Thus, it was surprisingly found that the use of colloidal materials in gypsum panels as described herein, even at relatively low load amounts, also provides for the manufacture of lightweight gypsum panels having relatively high strength and nail pull properties, in addition to any fire resistance properties achieved.

Next, samples were prepared using colloidal alumina instead of colloidal silica and tested according to the above-described high temperature tests. In particular, NYACOL® AL20, commercially available from NYACOL® Nano Technologies, Inc., which is a 20%, by weight, aluminum oxide material having an average particle size of 60 to 90 nm, was combined at load rates of 35 lb/msf and 70 lb/msf per 1500 lb/msf full panels (i.e., according to the formulations of Tables 1 and 2). These panels were observed to behave similarly to the colloidal silica samples, and provided a reduction in shrinkage according to the high temperature shrinkage test, as well as according to the high temperature core integrity test, relative to the controls.

Thus, it has been discovered that gypsum panels, sheathing, roofing, or other construction boards or panels may be formed using colloidal materials, such as silica or alumina, to achieve fire resistance and/or physical properties comparable to similar boards containing vermiculite. These panels may be relatively lightweight while also providing a high fire resistance level, but without the use of, or using a lower relative amount of, vermiculite, as compared to commercially available panels. For example, the boards described herein may display similar or better thermal shrinkage and high temperature core integrity results than comparative boards containing vermiculite instead of the colloidal material, such as measured according to ASTM C1795-15: Standard Test Methods for High-Temperature Characterization of Gypsum Boards and Panels. Further, the panels containing colloidal materials were discovered to display less sag than a comparable board made with vermiculite under fire resistance testing.

While the disclosure has been described with reference to a number of embodiments, it will be understood by those skilled in the art that the invention is not limited to such disclosed embodiments. Rather, the invention can be modified to incorporate any number of variations, alterations, substitutions, or equivalent arrangements not described herein, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A gypsum panel, comprising:
a gypsum core comprising set gypsum and a colloidal material comprising colloidal silica, colloidal alumina, or both.

2. The gypsum panel of claim 1, wherein the colloidal material is present in the gypsum core in an amount, by weight, greater than any other component, other than the gypsum

3. The gypsum panel of claim 1, wherein the colloidal material is present in the gypsum core in an amount of about 1 lb/msf to about 300 lb/msf, for a gypsum panel having a thickness of about ¼ inch to about 1 inch.

4. The gypsum panel of claim 1, wherein the colloidal material is present in the gypsum core in an amount of about 1 lb/msf to about 200 lb/msf, for a gypsum panel having a thickness of about ¼ inch to about 1 inch.

5. The gypsum panel of claim 1, wherein the gypsum core is free of vermiculite.

6. The gypsum panel of claim 1, wherein the gypsum core further comprises vermiculite, perlite, clay, wollastonite, and/or diatomaceous earth.

7. The gypsum panel of claim 1, wherein the colloidal material is colloidal silica.

8. The gypsum panel of claim 7, wherein the colloidal silica comprises from about 7 to about 50 percent silicon dioxide.

9. The gypsum panel of claim 7, wherein the colloidal silica has an average particle surface area of from about 30 to about 1,100 m²/g.

10. The gypsum panel of claim 7, wherein the colloidal silica has a pH of from about 2 to about 12.

11. The gypsum panel of claim 7, wherein the colloidal silica comprises amorphous silicon dioxide.

12. The gypsum panel of claim 1, wherein the colloidal material is colloidal alumina.

13. The gypsum panel of claim 12, wherein the colloidal alumina comprises from about 7 to about 50 percent aluminum oxide.

14. The gypsum panel of claim 12, wherein the colloidal alumina comprises amorphous aluminum oxide.

15. The gypsum panel of claim 1, wherein the gypsum core further comprises starch in an amount effective to bind the gypsum to the colloidal material.

16. The gypsum panel of claim 15, wherein the starch comprises pregelatinized starch or a combination of uncooked and pregelatinized starch.

17. The gypsum panel of claim 15, wherein the starch is present in the gypsum core in an amount of about 1 lb/msf to about 70 lb/msf, for a gypsum panel having a thickness of about ¼ inch to about 1 inch.

18. The gypsum panel of claim 1, wherein the gypsum core further comprises a polyphosphate.

19. The gypsum panel of claim 18, wherein the polyphosphate is sodium trimetaphosphate.

20-27. (canceled)

28. A method of making a gypsum panel, comprising:
forming a first gypsum slurry by combining stucco, water, and a colloidal material comprising colloidal silica, colloidal alumina, or both; and
setting the first gypsum slurry to form at least part of a core of the gypsum panel.

29-67. (canceled)
